(19) United States
(12) Patent Application Publication
(10) Pub. No.: US 2022/0004840 A1
(43) Pub. Date: Jan. 6, 2022

(54) CONVOLUTIONAL NEURAL NETWORK-BASED DATA PROCESSING METHOD AND DEVICE

(71) Applicant: INSPUR SUZHOU INTELLIGENT TECHNOLOGY CO., LTD, Suzhou, Jiangsu (CN)

(72) Inventors: Guoqiang MEI, Suzhou, Jiangsu (CN); Rui HAO, Suzhou, Jiangsu (CN)

(73) Assignee: INSPUR SUZHOU INTELLIGENT TECHNOLOGY CO., LTD, Suzhou, Jiangsu (CN)

(21) Appl. No.: 17/281,267

(22) PCT Filed: Sep. 29, 2019
(86) PCT No.: PCT/CN2019/108928

§ 371 Date: Mar. 30, 2021

(30) Foreign Application Priority Data
Jun. 28, 2019 (CN) 201910580367.8

(51) Int. Cl. G06N 3/04; G06F 17/16; G06F 17/15

(52) U.S. Cl. CPC G06N 3/04; G06F 17/153; G06F 17/16

(57) ABSTRACT

Provided are a data processing method and device based on a convolutional neural network. For any convolutional layer in a convolutional neural network, calculation is performed by a convolution kernel of the convolutional layer, on elements of data inputted to the convolutional layer one by one so as to obtain convoluted values of the respective elements. Each calculation obtains a convoluted value, and this convoluted value and convoluted values of elements in the same region obtained by calculation through the same convolution kernel are added together to obtain an output element of the convolution kernel corresponding to the region. In this way, an output of a convolutional layer can be obtained after all convoluted values have been calculated without having to read convoluted values from a storage apparatus, thus enhancing data processing efficiency.

This application claims priority to Chinese Patent Application No. 201910580367.8, titled “DATA PROCESSING METHOD AND DEVICE BASED ON CONVOLUTIONAL NEURAL NETWORK”, filed on Jun. 28, 2019 with the China National Intellectual Property Administration (CNIPA), which is incorporated herein by reference in its entirety.

### FIELD

The present disclosure relates to deep learning technology, and in particular to a data processing method and device based on a convolutional neural network.

### BACKGROUND

With the development of deep learning technology, convolutional neural networks have been widely applied to many fields in life. For example, the convolutional neural networks may be used to process video data, audio data, image data or the like, so as to automatically detect similar videos, similar audios or similar images.

A convolutional neural network generally includes multiple convolution layers, and each of convolution layers includes multiple convolution kernels. In a conventional data processing method based on a convolutional neural network, generally for a convolution layer, multiple convolution values are first calculated based on an input of the convolution layer by using corresponding convolution kernels. Each calculated convolution value is stored in a storage device. After all convolution values are calculated, an output of the convolution layer is calculated based on the stored convolution values. Therefore, in the conventional method, it is required to frequently perform read operations and write operations on the storage device during operation, resulting in low processing efficiency.

### SUMMARY

Based on the above shortcomings in the conventional technology, a data processing method and device based on a convolutional neural network are provided according to the present disclosure, so as to improve data processing efficiency.

A data processing method based on a convolutional neural network is provided according to a first aspect of the present disclosure. The method includes:

transforming, for any convolution layer of the convolutional neural network, input data of the convolution layer into a first square matrix, where the first square matrix is an N-order square matrix, N is a positive integer which is set based on a parameter of the convolution layer, the input data includes multiple input matrices, the first square matrix is divided into multiple areas, where for each area, elements included in the area have a same matrix position, and a matrix position of an element represents a position of the element in an input matrix to which the element belongs;

for each convolution kernel of the convolution layer,
performing calculations on each element in the input data by using the convolution kernel to obtain a convolution value of the element in the input data, where in a process of performing calculations on each element in the input data by using the convolution kernel, each time a convolution value of an element is calculated, the convolution value of the current element and a convolution value of a previous element are added up to obtain an output element of the convolution kernel corresponding to an area, where the current element and the previous element belong to the same area, and the convolution value of the current element and the convolution value of the previous element are calculated by using the same convolution kernel, where the area refers to each area of the first square matrix; and
combining output elements of the convolution kernel corresponding to all areas, to obtain a calculation result of the convolution kernel, where calculation results of all convolution kernels of the convolution layer serve as an output of the convolution layer.

In an embodiment, performing calculations on each element in the input data by using all convolution kernels of the convolution layer includes:

inputting the first square matrix into each of multiple multipliers, such that each of the multiple multipliers performs calculations on each element in the input data by simultaneously using convolution kernels corresponding to the multiplier, where all convolution kernels of the convolution layer are allocated to the multiple multipliers in advance.

In an embodiment, each time a convolution value of an element is calculated, the convolution value of the current element and the convolution value of the previous element are added up by an adder, to obtain the output element of the convolution kernel corresponding to the area, and the output element is stored in a preset register.

In an embodiment, a calculation result of each convolution kernel of the convolution layer is an output matrix, and output matrices of all convolution kernels of the convolution layer serve as the output of the convolution layer;

after, for each convolution kernel of the convolution layer, all output elements calculated by the convolution kernel are combined to obtain a calculation result of the convolution kernel, the method further includes:
transforming the output of the convolution layer into a second square matrix, where the second square matrix is an N-order square matrix, the second square matrix is divided into multiple areas, where for each area, elements included in the area have a same matrix position, and a matrix position of an element represents a position of the element in an output matrix to which the element belongs.

In an embodiment, after, for each convolution kernel of the convolution layer, combining output elements of the convolution kernel corresponding to all areas, to obtain a calculation result of the convolution kernel, where calculation results of all convolution kernels of the convolution layer serve as an output of the convolution layer, the method further includes:

processing the output of the convolution layer by a pooling layer to obtain a pooled output of the convolution layer, where the pooled output of the convolution layer serves as input data of a next convolution layer of the convolution layer.

A data processing device based on a convolutional neural network is provided according to a second aspect of the present disclosure. The data processing device includes:

a transformation unit, configured to transform, for any convolution layer of the convolutional neural network, input data of the convolution layer into a first square matrix, where the first square matrix is an N-order square matrix, N is a positive integer which is set based on a parameter of the convolution layer, the input data includes multiple input matrices, the first square matrix is divided into multiple areas, where for each area, elements included in the area have a same matrix position, and a matrix position of an element represents a position of the element in an input matrix to which the element belongs;

a calculation unit, configured to perform, for each convolution kernel of the convolution layer, calculations on each element in the input data by using the convolution kernel to obtain a convolution value of the element in the input data, where in a process of performing calculations on each element in the input data by using the convolution kernel, each time a convolution value of an element is calculated, the convolution value of the current element and a convolution value of a previous element are added up to obtain an output element of the convolution kernel corresponding to an area, where the current element and the previous element belong to the same area, and the convolution value of the current element and the convolution value of the previous element are calculated by using the same convolution kernel, where the area refers to each area of the first square matrix;

a combination unit, configured to combine, for each convolution kernel of the convolution layer, output elements of the convolution kernel corresponding to all areas, to obtain a calculation result of the convolution kernel, where calculation results of all convolution kernels of the convolution layer serve as an output of the convolution layer.

In an embodiment, the calculation unit includes multiple multipliers; and

the calculation unit performs calculations on each element in the input data by using all convolution kernels of the convolution layer includes:

each of the multiple multipliers performs calculations on each element in the input data by simultaneously using convolution kernels corresponding to the multiplier, where all convolution kernels of the convolution layer are allocated to the multiple multipliers in advance.

In an embodiment, the calculation unit includes an adder and a register;

each time a convolution value of an element is calculated, the adder is configured to add the convolution value of the current element and the convolution value of the previous element up, to obtain the output element of the convolution kernel corresponding to the area, and the register is configured to store the output element.

In an embodiment, a calculation result of each convolution kernel of the convolution layer is an output matrix, and output matrices of all convolution kernels of the convolution layer serve as the output of the convolution layer; and

the transformation unit is further configured to:
transform the output of the convolution layer into a second square matrix, where the second square matrix is an N-order square matrix, the second square matrix is divided into multiple areas, where for each area, elements included in the area have a same matrix position, and a matrix position of an element represents a position of the element in an output matrix to which the element belongs.

In an embodiment, the data processing device further includes:

a pooling unit, configured to process the output of the convolution layer by a pooling layer to obtain a pooled output of the convolution layer, where the pooled output of the convolution layer serves as input data of a next convolution layer of the convolution layer.

A data processing method and device based on a convolutional neural network are provided according to the present disclosure. For any convolution layer of the convolutional neural network, calculations are performed on elements in the input data of the convolution layer one by one by using convolution kernels of the convolution layer to obtain convolution values of each element. Each time a convolution value of an element is calculated, the convolution value of the current element and a convolution value of a previous element are added up to obtain an output element of a convolution kernel corresponding to an area, where the current element and the previous element belong to the same area, and the convolution value of the current element and the convolution value of the previous element are calculated by using the same convolution kernel. With the data processing method according to the present disclosure, in a process of calculating convolution values, each time a convolution value is calculated, the convolution value is added to a convolution sum corresponding to the convolution value, to directly obtain elements in the output of the convolution layer finally. Therefore, in the present disclosure, the output of the convolution layer can be obtained after all convolution values have been calculated, without reading convolution values in the storage device for calculation, which effectively reduces interaction with the storage device in the process of calculating the output of the convolution layer, and thereby improves data processing efficiency.

### BRIEF DESCRIPTION OF THE DRAWINGS

In order to more clearly describe technical solutions in the embodiments of the present disclosure or in the conventional technology, drawings to be used in the description of the embodiments or the conventional technology are briefly introduced hereinafter. It is apparent that the drawings described below show merely the embodiments of the present disclosure, and those skilled in the art may obtain other drawings based on the provided drawings without any creative effort.

FIG. 1 is a schematic structural diagram of a model of a convolutional neural network according to an embodiment of the present disclosure;

FIG. 2a is a schematic diagram showing a convolution operation between matrices;

FIG. 2b is a schematic diagram of pooling a matrix;

FIG. 3 is a flowchart of a data processing method based on a convolutional neural network according to an embodiment of the present disclosure;

FIG. 4 is a schematic diagram of a data format for storing input data of a convolution layer of a convolutional neural network and a data format of an output of the convolution layer according to an embodiment of the present disclosure;

FIG. 5 is a schematic diagram of data formats of multiple convolution layers of a convolutional neural network according to an embodiment of the present disclosure;

FIG. 6 is a configuration diagram of devices for implementing a data processing method based on a convolutional neural network according to another embodiment of the present disclosure;

FIG. 7 is a flowchart of a data processing method based on a convolutional neural network according to another embodiment of the present disclosure;

FIG. 8 is a schematic diagram of input information of a data processing method based on a convolutional neural network according to another embodiment of the present disclosure; and

FIG. 9 is a schematic structural diagram of a data processing device based on a convolutional neural network according to an embodiment of the present disclosure.

### DETAILED DESCRIPTION OF THE EMBODIMENTS

Technical solutions in the embodiments of the present disclosure will be clearly and completely described below in conjunction with the drawings of the embodiments of the present disclosure. Apparently, the embodiments described below are only some embodiments of the present disclosure, rather than all the embodiments. Any other embodiments obtained by those skilled in the art based on the embodiments in the present disclosure without any creative effort fall within the protection scope of the present disclosure.

It should be noted that a key difference between a data processing method based on a convolutional neural network according to the present disclosure and the conventional processing method is that, in the conventional data processing method, input data of each convolution layer consists of multiple feature matrices (may also be regarded as feature maps), and the number of and the size of feature maps among different convolution layers are not the same; while in the data processing method based on a convolutional neural network according to any one of the embodiments of the present disclosure, input data of all convolution layers included in the convolutional neural network are uniformly transformed into feature matrices (feature maps) with a same size, such that all the convolution layers performs data processing based on input data in the same form. Based on the above transformation, during data processing for the convolution layers, a same or similar data storage format and a same or similar processing timing may be applied to each convolution layer. Therefore, during the data processing based on the whole convolutional neural network, it is not required to adjust the data storage format and processing timing, thereby effectively improving data processing efficiency.

The convolutional neural network is a model widely used in the field of deep learning. A trained convolutional neural network may be used to process input data to acquire a certain class of features of the input data, thus to analyze the input data. A convolutional neural network mainly includes several convolution layers, several pooling layers, a fully connected layer and a probability classification function. An input of the convolutional neural network is firstly processed by a first convolution layer, and then an output of the first convolution layer is inputted into a first pooling layer corresponding to the first convolution layer. The first pooling layer performs a pooling operation on the input data to obtain an output of the first pooling layer. Next, the output of the first pooling layer serves as an input of a second convolution layer. Then data is sequentially processed by a second pooling layer, a third convolution layer and so on, until an input of the fully connected layer is acquired. The input of the fully connected layer is processed by the fully connected layer to obtain an output of the fully connected layer. Then the output of the fully connected layer is processed by using the probability classification function, to obtain an output of the convolutional neural network, that is, a feature of the input data. The number of the convolution layers included in the convolutional neural network may be determined according to actual conditions. As described above, the number of the pooling layers included in the convolutional neural network is equal to the number of the convolution layers.

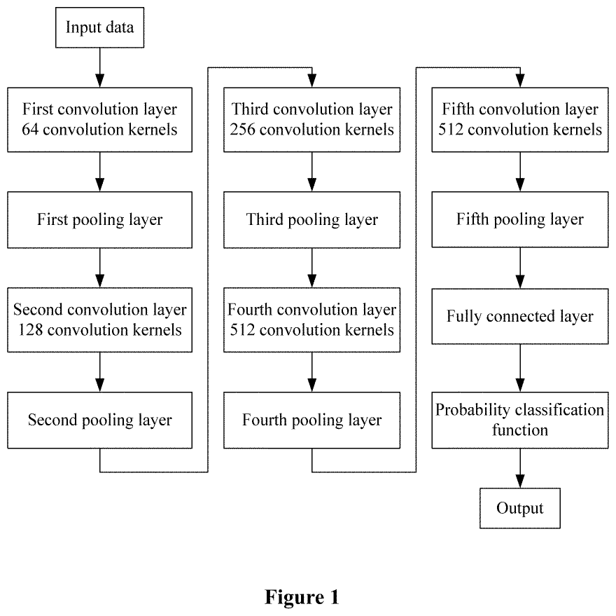

As shown in FIG. 1, a common convolutional neural network includes five convolution layers, five pooling layers, one fully connected layer and one probability classification function. Each of the convolution layers includes multiple convolution kernels. Specifically, in the common convolutional neural network shown in FIG. 1, a first convolution layer includes 64 convolution kernels, a second convolution layer includes 128 convolution kernels, a third convolution layer includes 256 convolution kernels, and a fourth convolution layer and a fifth convolution layer each includes 512 convolution kernels. Processing of input data by a convolution layer is to use convolution kernels included in the convolution layer itself to perform an operation on the input data.

In a convolutional neural network, input data and output data of a convolution layer and a pooling layer may be considered to be composed of one or more matrices. A matrix constituting the input data may be referred to as an input matrix. For example, for the convolutional neural network shown in FIG. 1, three 224-order square matrices may serve as input data of the convolutional neural network, or in other word, as an input of the first convolution layer of this convolutional neural network. The processing of the input data by the first convolution layer is to use the 64 convolution kernels of the first convolution layer itself to perform an operation on each of the three 224-order square matrices.

The 64 convolution kernels of the first convolution layer are different from each other, and each of the 64 convolution kernels needs to perform calculations on the input data (that is, the three 224-order square matrices), to obtain calculation results corresponding to the convolution kernels respectively. That is, a first convolution kernel of the first convolution layer is used for performing calculations on the input data to obtain a calculation result of the first convolution kernel, a second convolution kernel of the first convolution layer is used for performing calculations on the input data to obtain a calculation result of the second convolution kernel, and so on, to obtain 64 calculation results finally. The 64 calculation results serve as an output of the first convolution layer. Data processing on other convolution layers in the convolutional neural network is similar to the above process.

Performing calculations on input data by using a convolution kernel actually means performing a convolution operation on an input matrix by using a coefficient matrix of the convolution kernel itself and then adding results of convolution operations together to obtain a calculation result corresponding to the convolution kernel. Specifically, a convolution kernel includes several coefficient matrices, and the number of the coefficient matrices is equal to the number of input matrices constituting the input data. For example, for the above input data constituted by three 224-order square matrices, a convolution kernel for calculation includes three coefficient matrices. The coefficient matrix is generally a 3-order square matrix or a 5-order square matrix. Apparently, the order of the coefficient matrix may be increased according to actual needs. In addition, coefficient matrices of a convolution kernel are in one-to-one correspondence with input matrices in input data. That is, each of the above three coefficient matrices corresponds to one input matrix. Values of elements in all coefficient matrices included in a convolution kernel are determined in a process of training a convolutional neural network with sample data.

Performing a convolution operation on an input matrix by using a coefficient matrix refers to calculating a convolution value of each element in the input matrix by using the coefficient matrix, and arranging the calculated convolution values according to positions of their corresponding elements in the input matrix, to obtain a result of the convolution operation.

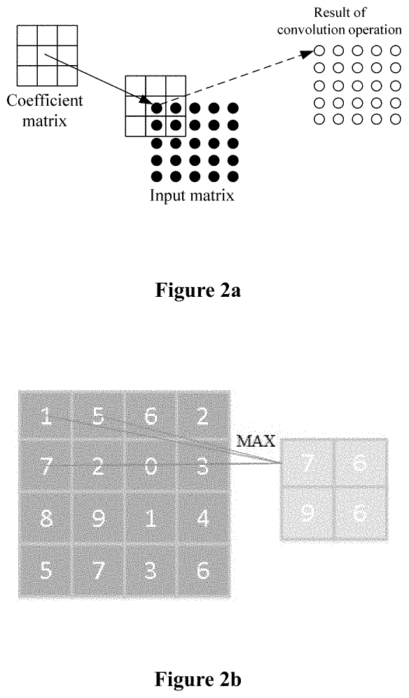

Referring to FIG. 2a, performing a convolution operation on an input matrix includes the following operations. An element located at a central position of the coefficient matrix (in FIG. 2a, that is an element located at the second row and the second column of the coefficient matrix) is aligned with an element of the input matrix, for example, aligned with an element located at the first row and the first column of the input matrix, such that a part of elements or all elements of the coefficient matrix correspond to a part of elements in the input matrix. As shown in FIG. 2a, there are four boxes, representing elements in the coefficient matrix, each of which includes a point representing an element of the input matrix. Then elements in the coefficient matrix are multiplied by corresponding elements respectively, to obtain multiple products. For example, in FIG. 2a, the element (denoted as X22) located at the second row and the second column of the coefficient matrix is multiplied by the element (denoted as Y11) located at the first row and the first column of the input matrix, an element X23 is multiplied by an element Y12, an element X32 is multiplied by an element Y21, and an element X33 is multiplied by an element Y22, thus to obtain four products. The four products are added up, to obtain a convolution value of the element located at the first row and the first column of the input matrix corresponding to the coefficient matrix. The above process is also applied to other elements of the input matrix, thus to perform calculations on each element of the input matrix by using the coefficient matrix. Calculated convolution values are arranged according to positions of their corresponding elements in the input matrix, to obtain a result of the convolution operation. That is, in the result (which is also a matrix) of the above convolution operation, the calculated convolution value of the element located at the first row and the first column of the input matrix is an element located at the first row and the first column in the result of the convolution operation. Cases for other convolution values are similar.

It should be noted that as shown in FIG. 2a, in performing a convolution operation on the input matrix, there may be a case that part of elements in the coefficient matrix do not correspond to elements of the input matrix. In this case, only a product of elements that correspond to each other is considered. Therefore, in the above calculation, only four products are added up. Apparently, if nine elements of the coefficient matrix each has a correspondence with an element of the input matrix, then nine products need to be calculated and added up.

It should also be noted that, as described above, a convolution layer includes multiple convolution kernels that are different from each other, and each convolution kernel needs to use its coefficient matric to perform a convolution operation on the input matrix. Moreover, for each element in the input data, only a coefficient matrix of the convolution kernel corresponding to an input matrix in which the element is located may be used in performing a calculation on the element. Therefore, for each element in the input data, multiple convolution values may be calculated with this element, and each convolution value corresponds to a convolution kernel. The number of the convolution values is equal to the number of convolution kernels included in the convolution layer.

For a convolution kernel, after convolution operations have been performed on all coefficient matrices of the convolution kernel with input matrices corresponding to the coefficient matrices, elements in results of the convolution operations are correspondingly added up, to obtain a calculation result corresponding to the convolution kernel.

For example, a convolution kernel includes three coefficient matrices. After convolution operations have been performed on the three coefficient matrices, three results of convolution operations are obtained, that is, three matrices are obtained. The three matrices are added up to obtain a calculation result of the convolution kernel. Apparently, the calculation result of the convolution kernel is still a matrix.

For a convolution layer, a set of calculation results of all convolution kernels of the convolution layer serves as an output of the convolution layer.

Performing a pooling operation on the input data by a pooling layer refers to performing a pooling operation on each input matrix in the input data. As shown in FIG. 2b, performing a pooling operation on a matrix refers to: dividing the matrix into multiple areas each of which includes two rows and two columns, where the multiple areas do not overlap each other; then extracting an element with the largest value in each area as an output of the area; and finally arranging outputs of the multiple areas according to corresponding positions, to obtain a result of the pooling operation. Results of pooling operations for all input matrices in the input data constitute an output of the pooling layer.

From the above introductions of a convolutional neural network, it can be found that in processing data by a convolutional neural network, it is required to calculate multiple convolution values and obtain a sum of the multiple convolution values. In the conventional data processing method based on a convolutional neural network, generally, all convolution values of a convolution layer are calculated firstly, then the convolution values are combined correspondingly to form multiple results of convolution operations, and finally, the multiple results of the convolution operations are added up to obtain a calculation result of each corresponding convolution kernel. It is apparent that in the above calculation processes, each calculated convolution value needs to be stored in a memory of a computer for processing data, and after all convolution values have been calculated, it is required to read the convolution values from the memory so as to calculate a sum of the convolution values. Therefore, in the conventional data processing method based on a convolutional neural network, it is required to read and write the memory of the computer for many times, which greatly reduces data processing efficiency.

In addition, in the conventional processing method based on a convolutional neural network, input data of each convolution layer includes multiple matrices (a matrix included in input data may also be regarded as a feature map), and for different convolution layers, the number of the multiple matrices is different and the number of rows and the number of columns in a matrix are also different, resulting in that during data processing based on the whole convolutional neural network, it is required to frequently modify a data storage format and a corresponding processing timing based on a format of the input data, which further reduces data processing efficiency.

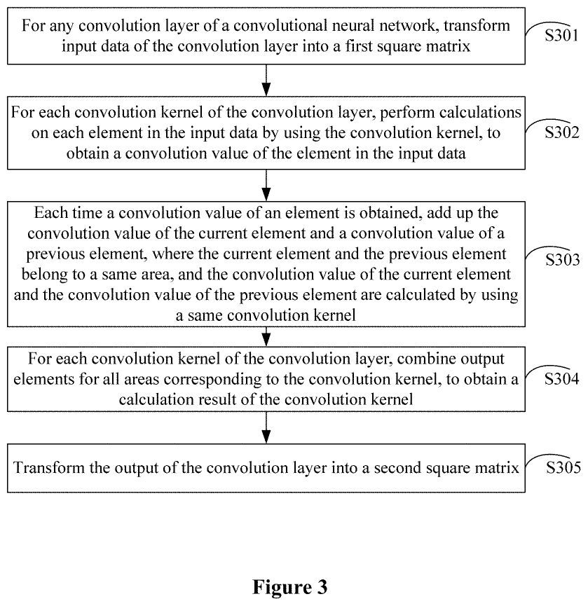

In view of the above, a data processing method based on a convolutional neural network is provided according to an embodiment of the present disclosure. Referring to FIG. 3, the method includes the following steps.

It should be noted that for convolution layers in the convolutional neural network, a process of processing data by a convolution layer is basically the same as that of other convolution layer, except that the number and values of parameters for processing data are different. The data processing method according to the embodiments of the present disclosure is mainly about improving a processing process of each convolution layer of the convolutional neural network. Moreover, in the following descriptions of the embodiments of the present disclosure, it will be found that improvement of any convolution layer with the method provided in the present disclosure may be directly applied to other convolution layers by simply adjusting relevant parameters. Therefore, a process of the data processing method based on a convolutional neural network according to the embodiments of the present disclosure is described only based on one of convolution layers. Based on a processing process of one convolution layer, those skilled in the art may directly apply the data processing method for one convolution layer to any convolution layer of any convolutional neural network. Thus, an embodiment in which the data processing method according to the present disclosure is performed in connection with multiple convolution layers of multiple convolutional neural networks falls within the protection scope of the present disclosure.

For ease of understanding, the embodiment is described based on the following example.

The data processing method according to the embodiment is mainly applied to a convolution layer including 128 convolution kernels. Input data of the convolution layer includes 64 input matrices, and each of the input matrices is a 112-order square matrix. Based on the above descriptions of the convolutional neural network, each convolution kernel of the convolution layer includes 64 coefficient matrices and each of the coefficient matrices is a 3-order square matrix.

In step S301, for any convolution layer of a convolutional neural network, input data of the convolution layer is transformed into a first square matrix.

The first square matrix is an N-order square matrix, where N is a positive integer which is set based on a parameter of the convolution layer.

In the data processing method according to the embodiment of the present disclosure, input data of each convolution layer is uniformly transformed into the first square matrix in which the number of rows and the number of columns are both fixed to be N, which is equivalent to that multiple feature maps with different formats of a convolution layer in the conventional technology each is transformed into a first square matrix with a same size, where the first square matrix may also be regarded as a feature map with a size of N*N. Based on the above transformation, during data processing for the convolution layers, a same or similar data storage format and a same or similar processing timing may be used for each of the convolution layers. Thus, in a data processing process based on the whole convolutional neural network, it is not required to adjust the data storage format and the processing timing, thereby effectively improving data processing efficiency.

It should be noted that transforming the input data into the first square matrix in step S301 may be understood as storing each element in the input data in a form of a square matrix.

The order N of the first square matrix is determined mainly based on the number of rows and the number of columns of the input matrix of the convolution layer, and the number of convolution kernels of the convolution layer. Based on the above example, in an embodiment, the first square matrix may be set as a 1792-order square matrix.

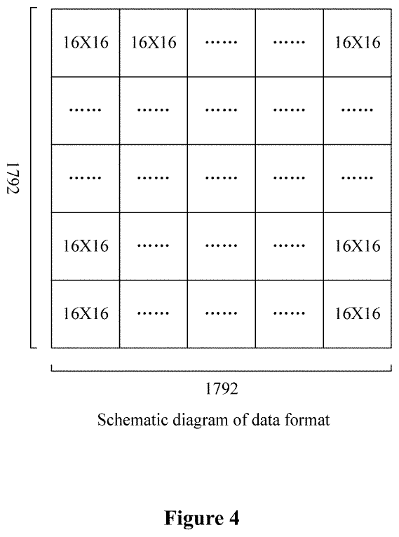

It should be noted that, the first square matrix is divided into multiple areas in advance, and the number of areas is equal to the number of elements included in the input matrix. That is, in the embodiment, the first square matrix is divided into 12544 (i.e., the square of 112) areas. If the first square matrix is set to be a 1792-order square matrix, the first square matrix may be divided as shown in FIG. 4.

In FIG. 4, each small box represents a square area with a size of 16×16, that is, a square area having 16 rows and 16 columns. It may be found that in a horizontal direction, the number of square areas included in each row is 112 (i.e., 1792 divided by 16); in a vertical direction, the number of square areas included in each column is also equal to 112. That is, the whole first square matrix includes 12544 square areas.

The process of transforming the input data into the 1792-order first square matrix as shown in FIG. 4 is described below.

Firstly, 64 input matrices included in the input data are numbered from 1 to 64. A specific correspondence between the 64 input matrices and the 64 numbers is not limited, as long as the 64 numbers are just assigned to the 64 input matrices and each input matrix corresponds to a number.

From the input matrix 1 to the input matrix 64, a first element of each input matrix is acquired sequentially. The acquired elements are filled in the first square area of the first square matrix in a form as shown in the following Table 1, that is, the acquired elements are filled in the square area located at the first row and the first column (in discussing a position of a square area, row and column are divided at intervals of square areas).

TABLE 1

| | | | | | | | |
|---|---|---|---|---|---|---|---|
| 1 | 1 | 2 | 2 | . . . | . . . | 8 | 8 |
| 1 | 1 | 2 | 2 | . . . | . . . | 8 | 8 |
| 9 | 9 | . . . | . . . | . . . | . . . | 16 | 16 |
| 9 | 9 | . . . | . . . | . . . | . . . | 16 | 16 |
| . . . | . . . | . . . | . . . | . . . | . . . | . . . | . . . |
| . . . | . . . | . . . | . . . | . . . | . . . | . . . | . . . |
| 57 | 57 | . . . | . . . | 63 | 63 | 64 | 64 |
| 57 | 57 | . . . | . . . | 63 | 63 | 64 | 64 |

A number in the Table 1 represents that an element in the box belongs to an input matrix numbered as the number. That is, in the first square box, a first row is filled from left to right with two first elements of the input matrix 1, two first elements of the input matrix 2, two first elements of the input matrix 3, and so on, until two first elements of the input matrix 8. Numbers filled in a second row are exactly the same as the numbers filled in the first row. A third row is filled with numbers from an input matrix 9 to the first element of an input matrix 16, according to a similar way to the previous row. Numbers filled in a fourth row are exactly the same as the numbers filled in the third row. That is, the first square area includes first elements of the 64 input matrices, and each of the first elements is copied into four copies.

In an embodiment, the above Table 1 only shows a filling manner, while in another filling manner, four copies of a first element of an input matrix may be filled in a same row.

It should be noted that the above first element refers to an element located at the first row and the first column of a matrix. For convenience, in discussing a position of an element in the input matrix in the present disclosure, it is based on a promise that elements in the input matrix are numbered in an ascending order from left to right and in an ascending order from top to bottom. Thus, for the above input matrix, the second element refers to an element located at the first row and the second column of the input matrix, and the 113-th element refers to an element located at the second row and the first column of the input matrix. Similar definition is made on a position of an area in the first square matrix.

Other square areas of the first square matrix are filled according to the filling manner of the first square area. In the first square matrix finally obtained, for any square area (e.g., an i-th square area), elements in the area include the i-th elements of all the 64 input matrices and each of the i-th elements is copied into four copies.

In step S302, for each convolution kernel of the convolution layer, a calculation is performed on each element in the input data by using the convolution kernel, to obtain a convolution value of the element in the input data.

It should be noted that steps S302 and S303 both need to be repeated multiple times. Moreover, during the execution of step S302, each time a convolution value of an element is calculated, step S303 needs to be performed once, and then step S302 is performed.

It should be noted that, step S302 simply points out that each convolution kernel is required to be used in performing a calculation on each element of the input data as described in step S302, but it is not limited that only one convolution kernel may be used in once calculation. In the method according to the embodiment of the present disclosure, depending on the number of copies of an element of the input data copied in the first square matrix and the number of multipliers for calculating a convolution value, the calculation described in step S302 may be performed by simultaneously using multiple convolution kernels.

In the embodiment, assuming that only one multiplier is used to perform step S302, based on the above description, it may be found that each element in the input data is copied into four copies in the first square matrix. Thus, in the embodiment, the above calculation may be performed by simultaneously using four convolution kernels of the convolution layer.

That is, for the first square matrix, it may be used four convolution kernels to simultaneously perform calculations on four copies of the first element of the input matrix 1 which are stored in the first square matrix, to obtain four different convolution values, and next, step S303 is performed. After step S303 is performed, it may be used four convolution kernels to simultaneously perform calculations on four copies of the first element of the input matrix 2 which are are stored in the first square matrix, to obtain four convolution values, and then step S303 is performed. The above processes are repeated.

As described above, calculating a convolution value of an element in the input data by using a convolution kernel actually refers to performing a convolution operation on the element by using a coefficient matrix in the convolution kernel, where the coefficient matrix corresponds to an input matrix to which the element belongs.

In step S302, an element for calculation is read from the first square matrix. While in calculating a convolution value of the element, it needs to use elements in an input matrix to which the element belongs, rather than directly making a one-to-one correspondence between elements in the coefficient matrix and elements in the first square matrix.

Specifically, in step S302, in calculating a convolution value of an element, it firstly needs to determine, from a convolution kernel for calculation, a coefficient matrix corresponding to an input matrix to which the element belongs; then, an element located at a center of the coefficient matrix is corresponded to the element for calculation; next, according to the process of convolution operation described above, other elements of the input matrix to which the element for calculation belongs are read from the first square matrix stored in the memory, and then calculation is performed according to the process of convolution operation described above.

For example, in the embodiment, for the first element of the input matrix 1 stored in the first square matrix, in calculating a convolution value of the element by using a convolution kernel (assumed to be a convolution kernel A), it is firstly found out, in the convolution kernel A, a coefficient matrix corresponding to the input matrix 1, and then an element located at a center of the coefficient matrix is corresponded to the first element of the input matrix 1. Based on the above description of convolution operation, in this case, an element (i.e., an element X23) located at a second row and a third column of the coefficient matrix corresponds to an element (an element Y12) located at a first row and a second column of the input matrix 1, an element X32 corresponds to an element Y21, and an element X33 corresponds to an element Y22. Therefore, the above three elements of the input matrix 1 are read from the first square matrix, and then a convolution value of the first element of the input matrix 1 is calculated by using the read three elements, the above element for calculation (i.e., the first element of the input matrix 1) and the coefficient matrix corresponding to the input matrix 1. Moreover, as described above, this convolution value corresponds to the convolution kernel A.

In step S303, each time a convolution value of an element is obtained, the convolution value of the element and a convolution value of a previous element are added up, where the previous element belongs to a same area as the element, and the convolution value of the previous element is obtained through a calculation by using a same convolution kernel as the element.

The execution of step S303 is described specifically below in conjunction with the above embodiments.

Taking a convolution kernel (denoted as a convolution kernel A) as an example, in performing step S302 for the first time, the convolution kernel A reads the first element of the input matrix 1 from the first square matrix, and then calculates a convolution value of the element. At this moment, convolution values of other elements have not been calculated. Thus, the adding operation as described in step S303 means storing the convolution value of the first element of the input matrix 1, which is calculated by the convolution kernel A.

After the convolution value is stored, step S302 is performed again. That is, an element of the input matrix 2 is read from the first square area of the first square matrix, and a convolution value of the element of the input matrix 2 is calculated. Then step S303 is performed. In step S303, it is determined that the convolution value currently calculated and the convolution value previously calculated belong to the same square area (i.e., both located at the first square area) of the first square matrix, and the two convolution values are both calculated by using the convolution kernel A. Thus, the current convolution value and the previous convolution value are added up to obtain a convolution sum, and the two convolution values are deleted.

In subsequent calculation processes, each time a convolution value is calculated by using the convolution kernel A, in a case that the convolution value is a convolution value of an element stored in the first square area of the first square matrix, the convolution value is added to the above convolution sum in step S303. The convolution sum currently obtained is stored, and the previous convolution sum and the previous convolution values are deleted. The above process is repeated until convolution values of 64 different elements respectively belonging to the 64 input matrices are calculated by using the convolution kernel A, where the 64 different elements are stored in the first square areas of the first square matrix. A convolution sum obtained by adding 64 convolution values up is an output element obtained through calculations for the first square area of the first square matrix by using the convolution kernel A.

In an embodiment, the adding process described in step S303 may be implemented by an adder. The convolution sum obtained through the adding process may be stored in a register.

Calculations for other square areas of the first square matrix by using other convolution kernels are basically the same as the above process, which are not repeated herein.

As described above, by performing steps S302 and S303 repeatedly, for each convolution kernel of the convolution layer, output elements of the convolution kernel may be obtained for all square areas of the first square matrix respectively. In the embodiment, the convolution layer includes 128 convolution kernels and the first square matrix includes 112×112 square areas, and thus there are 112×112×128 output elements finally obtained.

In step S304, for each convolution kernel of the convolution layer, output elements for all areas corresponding to the convolution kernel are combined, to obtain a calculation result of the convolution kernel.

Calculation results corresponding to all convolution kernels of the convolution layer serve as an output of the convolution layer.

As described above, a calculation result of a convolution kernel is also a matrix. In the embodiment, for a convolution kernel, 112×112 output elements may be calculated finally. Moreover, each of the output elements corresponds to a square area of the first square matrix. A matrix obtained by combining the output elements according to positions of their corresponding square areas in the first square matrix is the calculation result of the convolution kernel.

For example, in the calculation result of the convolution kernel A, the first element is an output element of the convolution kernel A for the first square area of the first square matrix, the second element is an output element for the second square area of the first square matrix, and so on. Thus, the calculation result of the convolution kernel A may be obtained by combining the output elements together. It can be seen that the calculation result for the convolution kernel, as a matrix, has the same number of elements and the same arrangement of elements as the number of square areas and the arrangement of the square areas in the first square matrix. Therefore, the calculation result of the convolution kernel is a matrix with a size of 112×112.

In the embodiment, the convolution layer includes 128 convolution kernels, and correspondingly, there are 128 calculation results of the convolution kernels. That is, 128 112-order square matrices calculated by using the 128 convolution kernels serve as an output of the convolution layer.

In an embodiment, the method according to the embodiment further includes the following step S305.

In step S305, the output of the convolution layer is transformed into a second square matrix.

The second square matrix is an N-order square matrix. The second square matrix is divided into multiple areas. For each area, elements included in the area have the same matrix position. A matrix position of an element represents a position of the element in an output matrix to which the element belongs.

It is known that the output of the convolution layer in the embodiment is 128 112-order square matrices. A process of transforming the square matrices into the second square matrix is similar to the above process of transforming the input data of the convolution layer into the first square matrix, which is not repeated herein.

It should be noted that in the embodiment, the second square matrix obtained by transforming the 128 112-order square matrices is still divided into square areas each of which includes 16 rows and 16 columns. According to the filling manner described above, the first square area of the second square matrix is filled with first elements of the 128 output matrices; the second square area is filled with second elements of the 128 output matrices; and so on. Each of the square areas includes elements from the 128 output matrices, and thus, each output element in the second matrix is copied only once. That is, the first row of the first square area is filled with first elements of 8 output matrices and each of the first elements is copied into two copies; the second row is filled with first elements of other 8 output matrices and each of the first elements is copied into two copies. A process of filling elements in other areas is similar to the above process.

It can be seen from the above calculation process that, in calculating output elements of a convolution kernel with the data processing method based on a convolutional neural network according to the embodiment of the present disclosure, for the steps S302 and S303, each time a convolution value of an element is calculated, the convolution value of the element and a convolution value of a previous element are added up, where the previous element belongs to a same area as the element, and the convolution value of the previous element is calculated by using a same convolution kernel as the element; and the added result is stored. In this way, in processing input data of a convolution layer with the data processing method according to the embodiment of the present disclosure to obtain an output, there is no need to store all calculated convolution values, which effectively reduces an occupied storage space. Moreover, based on this method, after calculations are performed for all elements in the input data by using a convolution kernel, all output elements corresponding to the convolution kernel may be directly obtained, such that a calculation result of the convolution kernel may be obtained by directly combining the output elements without reading all convolution values from the memory for calculation. Therefore, the number of access to the memory in the process of calculating the output of the convolution layer can be effectively reduced, thereby improving data processing efficiency.

By copying elements of the input data in the first square matrix, in reading an element for calculation in the input data from the first square matrix, multiple copies of the element of the input data can be read simultaneously by using multiple convolution kernels. In this way, calculations are performed on the same element of the input data by simultaneously using multiple convolution kernels, to obtain multiple convolution values, which effectively improves a data processing speed.

In the above embodiments, the data processing method according to the present disclosure is described by taking a convolution layer of a convolutional neural network as an example. Those skilled in the art may directly apply the above method to all convolution layers of a convolutional neural network. Taking the convolutional neural network shown in FIG. 1 as an example, a method for applying the method for one convolution layer in the above embodiments to the whole convolutional neural network is described below.

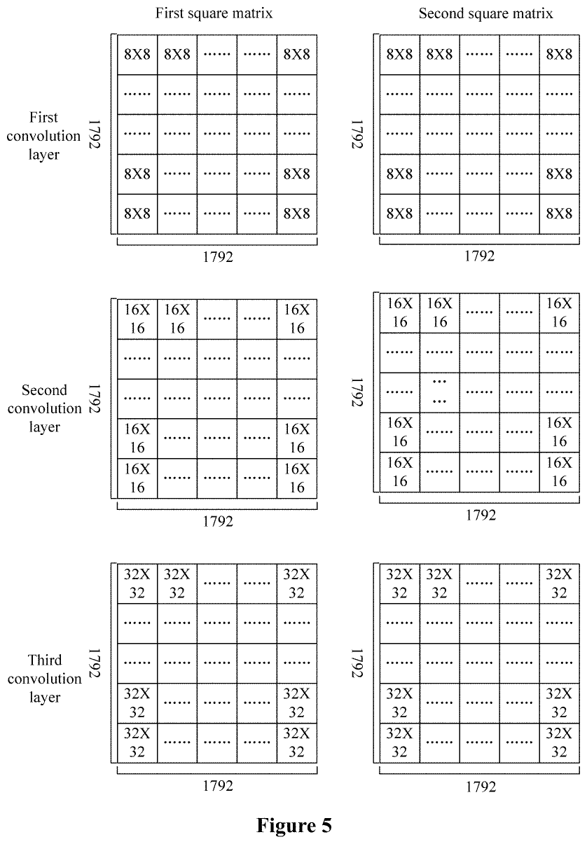

Input data of the first convolution layer is acquired first. It is assumed that the input data of the first convolution layer includes three 224-order square matrices. Then the three 224-order square matrices are transformed into a first square matrix of the first convolution layer in the manner described in the above embodiments, where the first square matrix is a 1792-order square matrix and a form of the first square matrix is shown in FIG. 5. Each 8×8 square area is filled with elements located at corresponding positions in the three 224-order square matrices. Taking the first 8×8 square area as an example, first elements of the three 224-order square matrices may be recorded as R1, G1 and B1 respectively, and a combination of the three elements is recorded as {R1 G1 B1}. {R1 G1 B1} is copied into 64 copies and the 64 copies serve as 64 elements in the first 8×8 square area.

Then for the first convolution layer, input data of the first convolution layer is processed with the data processing method according to the previous embodiment, to obtain an output of the first convolution layer. Considering that the first convolution layer includes 64 convolution kernels and in a convolution layer, the number of rows and the number of columns of a calculation result of a convolution kernel are respectively equal to the number of rows and the number of columns of an input matrix, an output of the first convolution layer may be represented as 224×224×64, that is, 64 224-order square matrices. The output of the first convolution layer may be transformed into a second square matrix shown in FIG. 5. It can be found that each area in the second square matrix includes 8 rows and 8 columns, such that each area can be exactly filled with elements located at corresponding positions of the 64 output matrices. Therefore, in the second square matrix corresponding to the first convolution layer, output elements are not copied and the number of each of output elements in the second square matrix is only one.

The first pooling layer connected to the first convolution layer performs a pooling operation on the output of the first convolution layer, to obtain a pooled output of the first convolution layer, that is, 64 112-order square matrices. The pooled output of the first convolution layer serves as an input of the second convolution layer. The input of the second convolution layer is transformed into a first square matrix of the second convolution layer as shown in FIG. 5, and then the first square matrix is processed with the data processing method according to the present disclosure, to obtain an output of the second convolution layer, that is, 128 112-order square matrices. The output of the second convolution layer is transformed into a second square matrix of the second convolution layer, as shown in FIG. 5.

The output of the second convolution layer passes through the second pooling layer to obtain a pooled output of the second convolution layer, that is, 128 56-order square matrices. Then the pooled output of the second convolution layer is inputted into the third convolution layer for processing. The third convolution layer transforms input data into a first square matrix including 56×56 square areas, each of which has a size of 32×32. In the first square matrix of the third convolution layer, each square area is filled with elements located at corresponding positions in the 128 input matrices, and each of the elements is copied into 8 copies. In the first 32×32 square area, the first row is filled with first elements of four input matrices and each first element is copied into 8 copies. That is, in the first row of the first 32×32 square area, each of the first eight elements is a first element of a same input matrix; each of the ninth element to the sixteenth element is a first element of another input matrix; and so on.

After the third convolution layer processes the input data of the third convolution layer with the method according to the above embodiments, an output of the third convolution layer includes 256 56-order square matrices since the third convolution layer includes 256 convolution kernels. A second matrix corresponding to the third convolution layer is divided into multiple 32×32 square areas. Each element in the output of the third convolution layer is copied into four copies in the second matrix of the third convolution layer. That is, in the second matrix, in the first row of the first 32×32 square area, each of the first four elements is a first element of a same input matrix; each of the fifth element to the eighth element is a first element of another input matrix; and so on.

Forms of a first square matrix and a second square matrix of the fourth convolution layer and forms of a first square matrix and a second square matrix of the fifth convolution layer are as shown in FIG. 5. For calculation of the four square matrices, reference may be made to the above descriptions, and the specific processes are not repeated.

In addition, the data processing method according to the embodiments of the present disclosure mainly makes an improvement on the processing of each convolution layer. For the processing of the fully connected layer and the probability classification function, reference may be made to the conventional technology, and the specific processes are not described herein.

In general, on a basis of determining each of a first square matrix and a second square matrix corresponding to each convolution layer to be a 1792-order square matrix, areas of the first square matrix and the second square matrix of each convolution layer are divided based on the number of rows and the number of columns of an input matrix of the corresponding convolution layer. Assuming that the number of rows and the number of columns of an input matrix of a convolution layer are both equal to ‘a’, a first square matrix corresponding to the convolution layer is divided into multiple b×b square areas, where ‘b’ is equal to a quotient obtained by dividing 1792 by ‘a’. Similarly, a second square matrix corresponding to the convolution layer is divided into multiple b×b square areas. After dividing the first square matrix and the second square matrix, the first square matrix and the second square matrix may be filled with elements based on correspondence between square areas and positions of elements in the input matrix or a calculation result. In a case that it is required to copy elements, the number of copies of an element is determined based on the number of input matrices and the number of convolution kernels of the convolution layer. For example, for a first square matrix divided into multiple b×b square areas, if the number of input matrices included in the input data is equal to ‘c’, each element in the input data is copied into d copies, where d is equal to a quotient obtained by dividing a square of b by c. For a second square matrix divided into multiple b×b square areas, if the number of convolution kernels included in the convolution layer is equal to e′, each output element constituting an output of the convolution layer is copied into f copies in the second square matrix, where f is equal to a quotient obtained by dividing a square of b by e. Each of a, b, c, d, e, and f is a positive integer.

As described above, for a convolution layer, convolution values of each element in the input data of the convolution layer may be calculated by a multiplier. Moreover, the convolution values may be added by an adder and a register.

In processing for a convolution layer, multiple multipliers and matching adders and registers may be configured. By controlling the above devices operate simultaneously, data processing efficiency of the convolution layer can be effectively improved.

In an optional device configuration, for a convolution layer, if each element of input data is copied into d copies in a first square matrix of the convolution layer, and the number of convolution kernels of the convolution layer is equal to e′, then for data processing of the convolution layer, it may be configured ‘g’ multipliers, where g is equal to a quotient obtained by dividing e by d and g is a positive integer. Moreover, each multiplier is configured with an adder and a register, correspondingly.

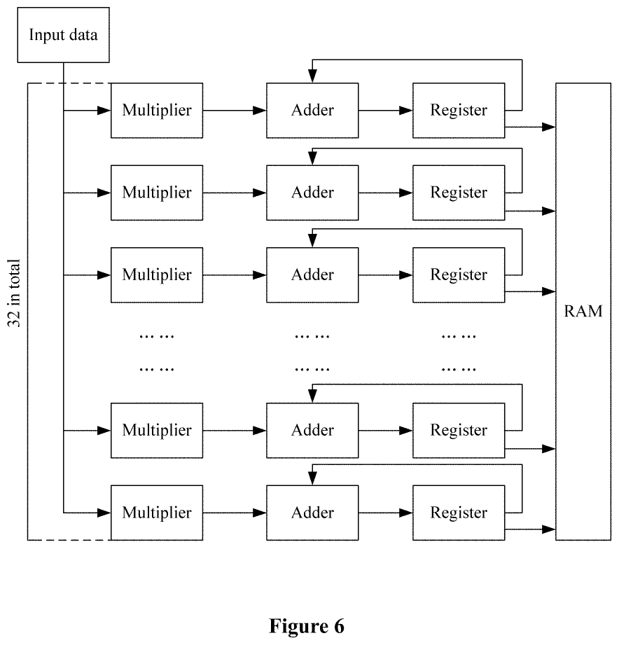

In conjunction with the above example in the embodiment shown in FIG. 3, for a convolution layer including 128 convolution kernels, input data includes 64 112-order input matrices. As described above, in the 1792-order first square matrix, each element of the input data is copied into four copies. Therefore, for the convolution layer, 32 multipliers may be configured, where 32 is obtained by dividing 128 by 4. Meanwhile, 32 adders and 32 registers are configured correspondingly. Connections between these devices are as shown in FIG. 6. RAM in FIG. 6 represents a memory configured to store calculation results of all convolution kernels of the convolution layer, that is, an output of the convolution layer.

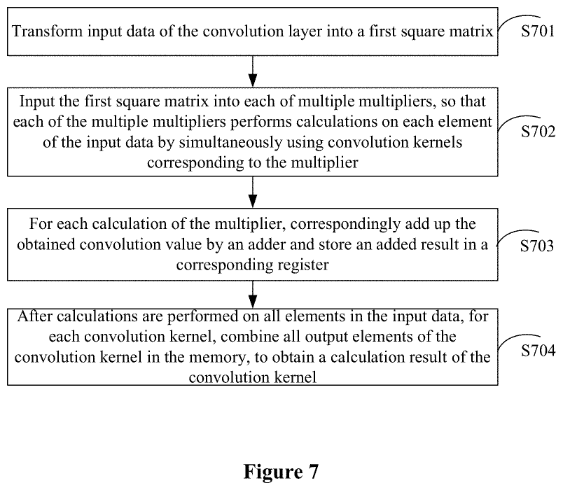

In conjunction with the device configuration shown in FIG. 6, referring to FIG. 7, a processing process for the above convolution layer with the data processing method according to the present disclosure includes the following steps S701 to S704.

In step S701, input data of the convolution layer is transformed into a first square matrix.

In the embodiment, 64 112-order input matrices are transformed into a 1792-order first square matrix.

In step S702, the first square matrix is inputted into each of multiple multipliers, so that each of the multiple multipliers simultaneously perform calculations on each element of the input data by simultaneously using convolution kernels corresponding to the multiplier.

The convolution kernels of the convolution layer are allocated to the multiple multipliers in advance. In the embodiment, each element in the input data is copied into four copies in the first square matrix, such that four convolution values may be calculated by simultaneously using four convolution kernels during once operation of each multiplier. Therefore, in the embodiment, 128 convolution kernels of the convolution layer are equally allocated to 32 multipliers, and each multiplier corresponds to four convolution kernels.

After the first square matrix is inputted, the 32 multipliers operate simultaneously. During once operation of each multiplier, the multiplier outputs four convolution values corresponding to an element in the input data. Specifically, the 32 multipliers firstly perform calculations on a first element of an input matrix 1. Then, the first multiplier obtains four convolution values of the first element of the input matrix 1. The four convolution values are calculated respectively by using four convolution kernels corresponding to the first multiplier. The second multiplier outputs four convolution values that are calculated respectively by using four convolution kernels corresponding to the second multiplier. Operations of other multipliers are similar to the above. That is, during once operation of the 32 multipliers, 128 (i.e., 32×4) convolution values corresponding to an element of the input data are obtained.

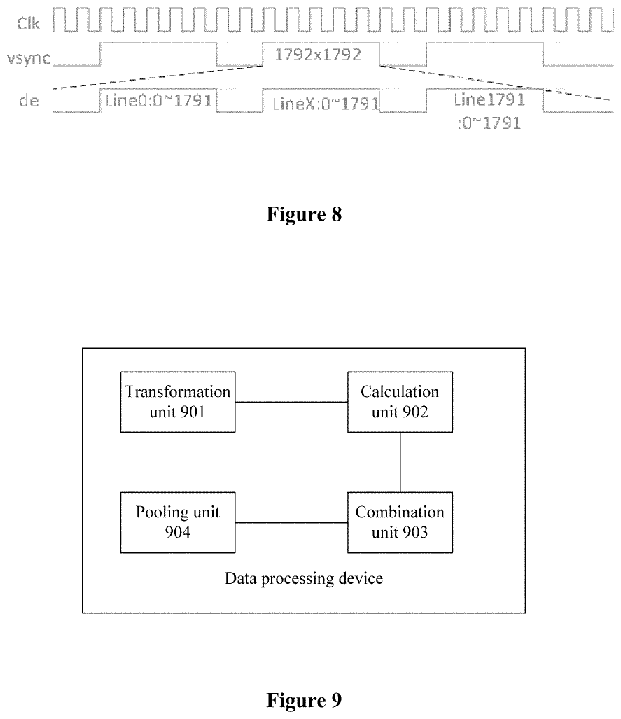

In an embodiment, in inputting the first square matrix into each of the multipliers, elements of the first square matrix may be inputted into each of the multiplier line by line. An input signal for inputting data may be referred to FIG. 8. In the FIG. 8, clk represents a clock signal, a vsync signal represents inputting a 1792-order square matrix, multiple de signals shows during an input signal of the 1792-order square matrix, and each de signal corresponds to a row of the 1792-order square matrix.

In step S703, for each calculation of the multiplier, the obtained convolution values are correspondingly added up by an adder, and an added result is stored in a corresponding register.

In step S703, after 128 convolution values are calculated, the 128 convolution values are inputted into the corresponding adders, and each adder receives four of the 128 convolution values.

After receiving the convolution values, the adder reads a previously stored convolution sum corresponding to the convolution values from a register. For example, a multiplier performs calculations on an element of the input data by using four convolution kernels A, B, C and D that corresponding to the multiplier, where the element of the input data is stored in the second square area of the first square matrix. To be exact, the four convolution kernels are used to perform calculations on four copies of the element respectively, to obtain four convolution values corresponding to the element, where the four convolution kernels are in one-to-one correspondence with the four copies. After acquiring the four convolution values, an adder reads four convolution sums respectively corresponding to the four convolution values from a register. Each of the four convolution sums is calculated based on an element of the input data which is also stored in the second square area of the first square matrix. Moreover, the four convolution sums are calculated by using the four convolution kernels A, B, C and D respectively. Then, the four convolution values are added to the corresponding convolution sums respectively to obtain 4 results as 4 new convolution sums, and the 4 new convolution sums replace the convolution sums previously stored in the register respectively.

Each time the adding operation is completed by the adder, proceed to step S702 to perform calculations on another element in the input data, and 128 convolution values are obtained.

After calculations are performed on all elements of the input data by repeating the above process, output elements of all convolution kernels are stored in registers. Each register corresponds to four convolution kernels, and each convolution kernel corresponds to 112×112 output elements. Therefore, each register stores 112×112×4 output elements.

As described above, every time steps S702 and S703 are performed, a process of calculating and adding up 128 convolution values for an element in the input data is completed once. Therefore, after both of steps S702 and S703 are performed for 112×112×64 times, convolution values corresponding to all elements in the input data are calculated. Then step S704 may be performed.

In step S704, after calculations are performed on all elements in the input data, for each convolution kernel, all output elements of the convolution kernel are combined in the memory, to obtain a calculation result of the convolution kernel.

After calculation processes of steps S702 and S703 are fully completed, output elements stored in registers are stored in the RANI. Calculation results of all convolution kernels are obtained by combining the output elements in the RANI according to corresponding positions, so as to obtain an output of the convolution layer.

With the method according to the embodiment, the number of multipliers, adders and registers are set based on the number of copies of the input data copied in the first square matrix and the number of convolution kernels of the convolution layer, such that multiple convolution values can be calculated by simultaneously using multiple multipliers, and added up by simultaneously using multiple adders, thereby improving an efficiency of the data processing method according to the embodiment.

By controlling a product of the number of the multipliers and the number of copies of the input data copied in the first square matrix to be equal to the number of convolution kernels of the convolution layer, in the embodiment, it can be ensured that for any convolution layer, an output of the convolution layer can be obtained by simply traversing each element of the input data once, thereby realizing an effect of an assembly line processing.

Apparently, the above devices configured for one convolution layer may be directly applied to data processing of other convolution layer of the convolutional neural network. Alternatively, the number of the devices may be adjusted based on other convolution layer to which the devices will be applied, and then the devices may be applied to the processing of other convolution layer.

In conjunction with the data processing method based on a convolutional neural network according to the above embodiments, a data processing device based on a convolutional neural network is further provided according to another embodiment of the present disclosure. As shown in FIG. 9, the data processing device includes a transformation unit 901, a calculation unit 902, and a combination unit 903.

The transformation unit 901 is configured to transform, for any convolution layer of the convolutional neural network, input data of the convolution layer into a first square matrix.

The first square matrix is an N-order square matrix, where N is a positive integer which is set based on a parameter of the convolution layer. The input data includes multiple input matrices. The first square matrix is divided into multiple areas. For each area, elements included in the area have the same matrix position. A matrix position of an element represents a position of the element in an output matrix to which the element belongs.

The calculation unit 902 is configured to perform, for each convolution kernel of the convolution layer, calculations on each element in the input data by using the convolution kernel to obtain a convolution value of the element in the input data; and in a process of performing calculations on each element in the input data by using a convolution kernel, each time a convolution value of an element is calculated, add the convolution value of the current element and a convolution value of a previous element up to obtain an output element of a convolution kernel corresponding to an area, where the current element and the previous element belong to the same area, and the convolution value of the current element and the convolution value of the previous element are calculated by using the same convolution kernel.

The above area refers to each area of the first square matrix.

The combination unit 903 is configured to combine, for each convolution kernel of the convolution layer, output elements of all areas corresponding to the convolution kernel together, to obtain a calculation result of the convolution kernel.

Calculation results of all convolution kernels of the convolution layer serve as an output of the convolution layer.

In an embodiment, the calculation unit 902 includes multiple multipliers.

The calculation unit 902 performs calculations on each element in the input data by using all convolution kernels of the convolution layer, includes the following steps:

Each of the multiple multipliers performs calculations on each element in the input data by simultaneously using convolution kernels corresponding to the multiplier, where all convolution kernels of the convolution layer are allocated to the multiple multipliers in advance.

The calculation unit 902 includes an adder and a register.

Each time a convolution value of an element is calculated, the calculation unit 902 adds the convolution value of the current element and a convolution value of a previous element up to obtain an output element of a convolution kernel corresponding to an area, where the current element and the previous element belong to the same area, and the convolution value of the current element and the convolution value of the previous element are calculated by using the same convolution kernel, includes the following steps:

Each time a convolution value of an element is calculated, the adder adds the convolution value of the current element and the convolution value of the previous element up to obtain the output element of the convolution kernel corresponding to the area, where the current element and the previous element belong to the same area, and the convolution value of the current element and the convolution value of the previous element are calculated by using the same convolution kernel.

The register is configured to store the output element.

A calculation result of each convolution kernel of the convolution layer is an output matrix, and output matrices of all convolution kernels of the convolution layer serve as an output of the convolution layer.

The transformation unit 901 is further configured to:

transform the output of the convolution layer into a second square matrix, where the second square matrix is an N-order square matrix, the second square matrix is divided into multiple areas. For each area, elements included in the area have the same matrix position. A matrix position of an element represents a position of the element in an output matrix to which the element belongs.

In an embodiment, the data processing device further includes a pooling unit 904.

The pooling unit 904 is configured to process the output of the convolution layer by using a pooling layer to obtain a pooled output of the convolution layer, where the pooled output of the convolution layer serves as input data of a next convolution layer of the convolution layer.

A data processing apparatus based on a convolutional neural network is provided according to the present disclosure. For any convolution layer of the convolutional neural network, the calculation unit 602 performs calculations on each element in the input data of the convolution layer by using convolution kernels of the convolution layer to obtain convolution values of the element. Each time a convolution value of an element is calculated, the calculation unit 902 adds the convolution value of the current element and a convolution value of a previous element up to obtain an output element of a convolution kernel corresponding to an area, where the current element and the previous element belong to the same area, and the convolution value of the current element and the convolution value of the previous element are calculated by using the same convolution kernel. With the data processing method according to the present disclosure, in a process of calculating convolution values, each time a convolution value is calculated, the convolution value is added to a convolution sum corresponding to the convolution value, to directly obtain elements in the output of the convolution layer finally. Therefore, in the present disclosure, the output of the convolution layer can be obtained after all convolution values have been calculated, without reading convolution values in the storage device for calculation, which effectively reduces interaction with the storage device in the process of calculating the output of the convolution layer, and thereby improves data processing efficiency.

Those skilled in the art may implement or use the present disclosure. Various modifications to the embodiments are apparent to those skilled in the art, and the general principles defined in the present disclosure may be implemented in other embodiments without departing from the spirit or scope of the present disclosure. Therefore, the present disclosure may not be limited to the embodiments described herein, but should comply with the widest scope consistent with the principles and novel features disclosed herein.

1. A data processing method based on a convolutional neural network, comprising:
transforming, for any convolution layer of the convolutional neural network, input data of the convolution layer into a first square matrix, wherein the first square matrix is an N-order square matrix, N is a positive integer which is set based on a parameter of the convolution layer, the input data comprises a plurality of input matrices, the first square matrix is divided into a plurality of areas, wherein for each area, elements comprised in the area have a same matrix position, and a matrix position of an element represents a position of the element in an input matrix to which the element belongs;
for each convolution kernel of the convolution layer,
performing calculations on each element in the input data by using the convolution kernel to obtain a convolution value of the element in the input data, wherein in a process of performing calculations on each element in the input data by using the convolution kernel, each time a convolution value of an element is calculated, the convolution value of the current element and a convolution value of a previous element are added up to obtain an output element of the convolution kernel corresponding to an area, wherein the current element and the previous element belong to the same area, and the convolution value of the current element and the convolution value of the previous element are calculated by using the same convolution kernel, wherein the area refers to each area of the first square matrix; and
combining output elements of the convolution kernel corresponding to all areas, to obtain a calculation result of the convolution kernel, wherein calculation results of all convolution kernels of the convolution layer serve as an output of the convolution layer.

2. The data processing method according to claim 1, wherein performing calculations on each element in the input data by using all convolution kernels of the convolution layer comprises:
inputting the first square matrix into each of a plurality of multipliers, such that each of the plurality of multipliers performs calculations on each element in the input data by simultaneously using convolution kernels corresponding to the multiplier, wherein all convolution kernels of the convolution layer are allocated to the plurality of multipliers in advance.

3. The data processing method according to claim 1, wherein each time a convolution value of an element is calculated, the convolution value of the current element and the convolution value of the previous element are added up by an adder, to obtain the output element of the convolution kernel corresponding to the area, and the output element is stored in a preset register.

4. The data processing method according to claim 1, wherein,
a calculation result of each convolution kernel of the convolution layer is an output matrix, and output matrices of all convolution kernels of the convolution layer serve as the output of the convolution layer;
after, for each convolution kernel of the convolution layer, all output elements calculated by the convolution kernel are combined to obtain the calculation result of the convolution kernel, the method further comprises:
transforming the output of the convolution layer into a second square matrix, wherein the second square matrix is an N-order square matrix, the second square matrix is divided into a plurality of areas, wherein for each area, elements comprised in the area have a same matrix position, and a matrix position of an element represents a position of the element in an output matrix to which the element belongs.

5. The data processing method according to claim 1, wherein after, for each convolution kernel of the convolution layer, combining output elements of the convolution kernel corresponding to all areas, to obtain a calculation result of the convolution kernel, wherein calculation results of all convolution kernels of the convolution layer serve as an output of the convolution layer, the method further comprises:
processing the output of the convolution layer by a pooling layer to obtain a pooled output of the convolution layer, wherein the pooled output of the convolution layer serves as input data of a next convolution layer of the convolution layer.

6. A data processing device based on a convolutional neural network, comprising:
a transformation unit, configured to transform, for any convolution layer of the convolutional neural network, input data of the convolution layer into a first square matrix, wherein the first square matrix is an N-order square matrix, N is a positive integer which is set based on a parameter of the convolution layer, the input data comprises a plurality of input matrices, the first square matrix is divided into a plurality of areas, wherein for each area, elements comprised in the area have a same matrix position, and a matrix position of an element represents a position of the element in an input matrix to which the element belongs;
a calculation unit, configured to perform, for each convolution kernel of the convolution layer, calculations on each element in the input data by using the convolution kernel to obtain a convolution value of the element in the input data, wherein in a process of performing calculations on each element in the input data by using the convolution kernel, each time a convolution value of an element is calculated, the convolution value of the current element and a convolution value of a previous element are added up to obtain an output element of the convolution kernel corresponding to an area, wherein the current element and the previous element belong to the same area, and the convolution value of the current element and the convolution value of the previous element are calculated by using the same convolution kernel, wherein the area refers to each area of the first square matrix; and
a combination unit, configured to combine, for each convolution kernel of the convolution layer, output elements of the convolution kernel corresponding to all areas, to obtain a calculation result of the convolution kernel, wherein calculation results of all convolution kernels of the convolution layer serve as an output of the convolution layer.

7. The data processing device according claim 6, wherein
the calculation unit comprises a plurality of multipliers; and
the calculation unit performs calculations on each element in the input data by using all convolution kernels of the convolution layer comprises:
each of the plurality of multipliers performs calculations on each element in the input data by simultaneously using convolution kernels corresponding to the multiplier, wherein all convolution kernels of the convolution layer are allocated to the plurality of multipliers in advance.

8. The data processing device according claim 6, wherein the calculation unit comprises an adder and a register, wherein
each time a convolution value of an element is calculated, the adder is configured to add the convolution value of the current element and the convolution value of the previous element up, to obtain the output element of the convolution kernel corresponding to the area, and
the register is configured to store the output element.

9. The data processing device according claim 6, wherein
a calculation result of each convolution kernel of the convolution layer is an output matrix, and output matrices of all convolution kernels of the convolution layer serve as the output of the convolution layer; and
the transformation unit is further configured to:
transform the output of the convolution layer into a second square matrix, wherein the second square matrix is an N-order square matrix, the second square matrix is divided into a plurality of areas, wherein for each area, elements comprised in the area have a same matrix position, and a matrix position of an element represents a position of the element in an output matrix to which the element belongs.

10. The data processing device according claim 6, wherein the data processing device further comprises:
a pooling unit, configured to process the output of the convolution layer by a pooling layer to obtain a pooled output of the convolution layer, wherein the pooled output of the convolution layer serves as input data of a next convolution layer of the convolution layer.
